(19) United States
(12) Patent Application Publication
(10) Pub. No.: US 2019/0257077 A1
(43) Pub. Date: Aug. 22, 2019

(54) BUILDING INSULATION SYSTEM

(71) Applicant: Mark A. Aspenson, (US)

(72) Inventors: Mark A. Aspenson, Waterloo, IA (US); John G. Connell, Tallahassee, FL (US)

(21) Appl. No.: 16/291,853

(22) Filed: Mar. 4, 2019

Related U.S. Application Data
(63) Continuation of application No. 13/652,442, filed on Oct. 15, 2012, now abandoned.
(60) Provisional application No. 61/548,099, filed on Oct. 17, 2011.

(51) Int. Cl. E04B 1/76; E04B 1/78

(52) U.S. Cl. CPC E04B 1/7604; E04B 1/78; E04B 2001/746; E04B 2001/7691; Y02A 30/248

(57) ABSTRACT

The building insulation system includes a reflective, non-porous bag filled with thermal insulation material. The covering of the bag is made from reflective polymeric facer or plastic, which facilitates reflection of thermal energy radiation. The reflective non-porous bag provides a thermal barrier for conduction, convection and radiation aspects of thermal energy transfer.

### CROSS-REFERENCE TO RELATED APPLICATION

This, application claims the benefit of U.S. Provisional Patent Application Ser. No. 61/548,099, filed Oct. 17, 2011.

### BACKGROUND OF THE INVENTION

### 1. Field of the Invention

The present invention relates to building construction systems, and particularly to a building insulation system that provides improved insulation for maintaining more moderate temperatures and reducing energy costs.

### 2. Description of the Related Art

Typical building insulation does not have the capacity to provide the full range of thermal barriers against different sources of thermal energy. For insulation to perform as well as possible, the insulation should be able to cope with three forms of thermal transfer, viz.; conduction, convection and radiation. The national and worldwide R-values for insulation are generally based upon only one form of heat transfer, viz., conduction. However, conduction only represents about 10% of the total thermal forces acting on a building, the remaining thermal forces being about 25% for convection and about 65% for radiation. Percentages may vary due to differences in climate zones. Thus, insulation with a high R-value provides excellent thermal break or barrier for conduction, but with no regard to convection and radiation. With about 90% of the thermal energy contributors not being taken into account in typical building insulation, this highlights the extent of thermal inefficiencies existing in homes and other buildings. As a consequence, these inefficiencies contribute to the high costs of heating and cooling a building.

In light of the above, it would be a benefit in the building arts to provide insulation having more efficient thermal protection in order to reduce energy costs. Thus, a building insulation system solving the aforementioned problems is desired.

### SUMMARY OF THE INVENTION

The building insulation system includes a reflective, non-porous bag filled with thermal insulation material. The covering of the bag is made from reflective polymeric facer or plastic, which facilitates reflection of thermal energy radiation. The reflective non-porous bag provides a thermal barrier for conduction, convection and radiation aspects of thermal energy transfer.

These and other features of the present invention will become readily apparent upon further review of the following specification and drawings.

### BRIEF DESCRIPTION OF THE DRAWINGS

FIG. 1 is an environmental, perspective view of a building insulation system according to the present invention.

FIG. 2 is a perspective of a reflective non-porous bag forming a part of a building insulation system according to the present invention.

FIG. 3 is a section view drawn along lines 3-3 of FIG. 2.

FIG. 4 is a perspective view of a reflective non-porous bag forming a part of a building insulation system according to the present invention, shown with sealing material being applied when the bag is cut to size during installation.

FIG. 5 is a perspective view of a reflective non-porous bag forming a part of a building insulation system according to the present invention, shown with sealing material being applied to an angled or beveled cut end of the bag.

FIG. 6 is a perspective view of an alternative embodiment of a reflective non-porous bag forming a part of a building insulation system according to the present invention, the bag having a cover tab.

Similar reference characters denote corresponding features consistently throughout the attached drawings.

### DETAILED DESCRIPTION OF THE PREFERRED EMBODIMENTS

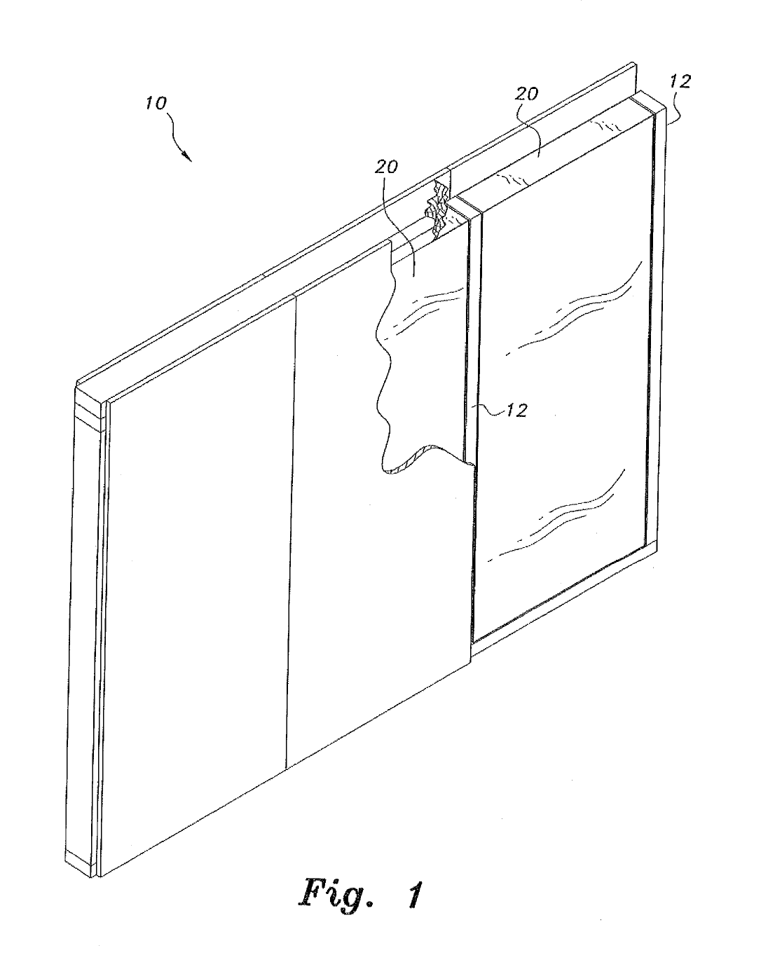

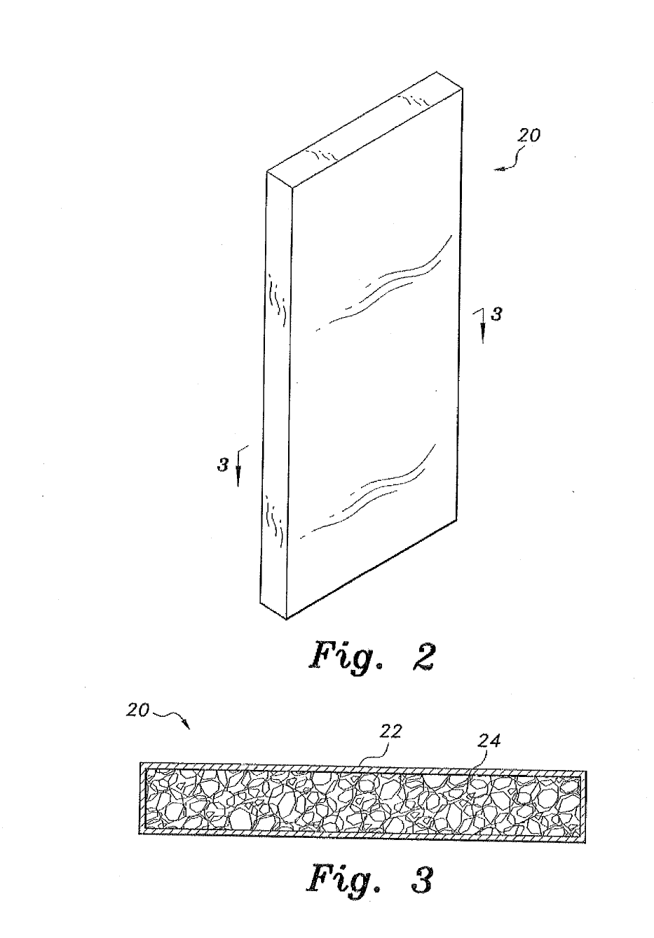

The building insulation system, generally referred to by the reference number 10, is configured to provide a thermal break for all three forms of thermal energy in a domicile or building. As shown in FIGS. 1-3, the building insulation system 10 includes a reflective, non-porous bag 20 filled with insulation material 24.

In the embodiment shown in the drawings, the covering 22 for the non-porous bag 20 can be made from a reflective polymeric facer or plastic, e.g., polyester or other polymeric sheet material with reflective metal mixed therein, similar to Mylar® (Mylar is a registered trademark of E.I. du Pont de Nemours and Company of Wilmington, Del.). The covering 22 completely encapsulates both opposing faces, both opposing sides, and both opposing ends of the bag 20 to provide a non-porous barrier that reflects thermal energy from the surface facing the outer wall or siding, i.e., the surface facing the environment, and also reflects thermal energy from the interior of the domicile. As a consequence, the radiated thermal energy from the interior remains substantially within the domicile, while the radiated thermal energy from the outside is reflected back. Thus, the covering 22 minimizes thermal energy loss within the domicile, which is especially beneficial for heating and reducing the costs thereof. The covering 22 can be provided in single-ply or in multiple-ply construction.

The insulation material 24 can be any one of, or a combination of, thermal insulation materials selected from fiberglass, cellulose, rockwool, expanded polystyrene, and others. Some of the polystyrene products can be constructed from recycled materials. The insulation material 24 forms a core within the bag 20 that minimizes the conduction aspect of thermal energy transfer. Some insulation materials may produce potential health issues due to fibers, dust, off gassing along with other concerns. However, since the material is sealed within the covering 22, any potential hazards from the insulation material are eliminated or potentially are significantly reduced.

In use, the building insulation system 10 can be installed in substantially the same manner as typical wall insulation. As shown in FIG. 1, each reflective non-porous bag 20 can be provided in standard sizes that fit between adjacent studs 12. The sizes may range from 2 ft.(w)×8 ft.(h)×3.5 in.(t), to 2 ft.(w)×12 ft. (h)×5.5 in. (t), where “w” refers to the width, “h” refers to the height and “t” refers to the thickness. Other sizes may be provided as desired or needed by the user. Due to the non-porous nature of the bag 20, a complete installation in a domicile or building forms an envelope that helps to prevent thermal energy transfer through convection.

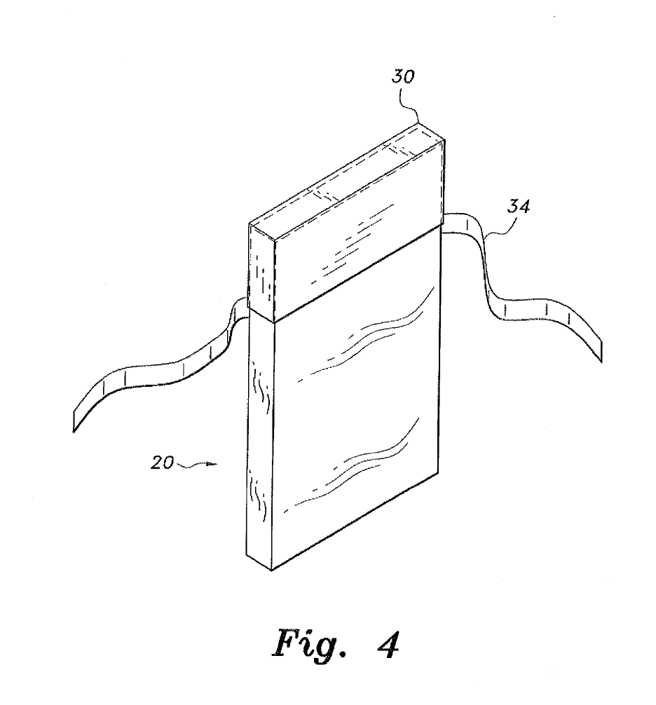

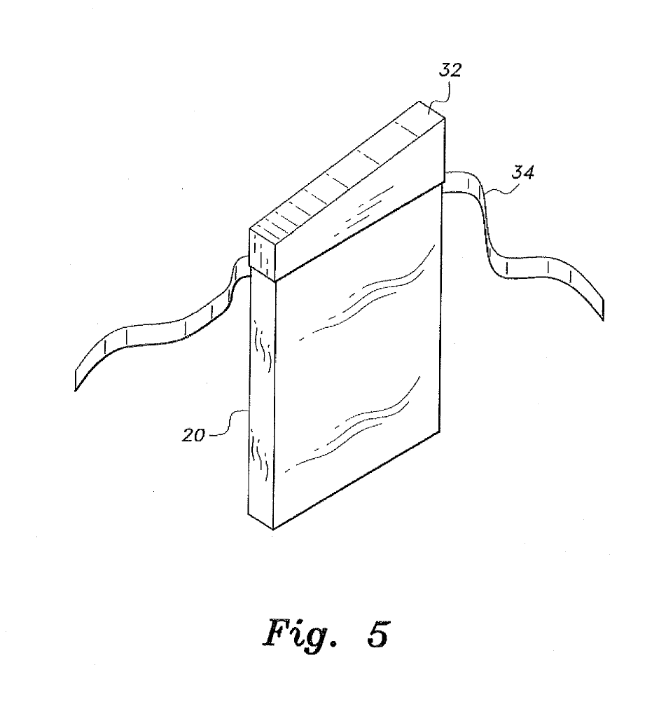

Referring to FIGS. 4 and 5, these figures show how to maintain the non-porous characteristic of the bag 20 in the event one or both of the ends have to be cut to size and/or shape. In general, it is often necessary to cut insulation down to size and/or shape the same during installation of the insulation. However, this practice would compromise the non-porous integrity of the bag 20. In order to insure that the bag 20 is sealed, a wrap 30 in the shape of a cap or sleeve can be provided to fit the cut end of the bag 20, thereby capping the cut end of the bag 20. Then the cap is sealed with adhesives or by tape 34. An alternative wrap 32 can be used for angled or beveled cut ends, such as for insulation on the rafters, ceilings and gables. The wraps 30, 32 are preferably of the same construction as the reflective, non-porous bag 20.

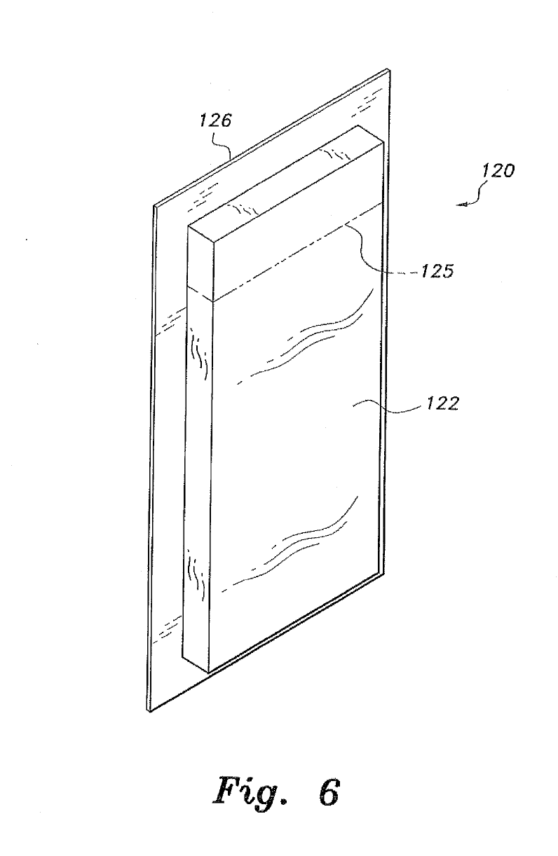

An alternative embodiment of a reflective, non-porous bag 120 is shown in FIG. 6, In this embodiment, the bag 120 is configured to provide a continuous moisture/vapor barrier behind the interior wall. This type of protection can be necessary in sonic areas where building codes require a moisture/vapor barrier behind the interior wall and not at the exterior wall, or in retrofit installations where there is no moisture/vapor barrier in the wall assembly. As shown, the bag 120 includes an outer covering 122 filled with insulation material 24 in substantially the same manner as the previously described bag 20. In addition, the bag 120 includes surrounding cover tab or flange 126. The cover tab 126 can be constructed from the same reflective and non-porous material as the covering 22 or outer covering 122. In use, the cover tab 126 overlaps or covers the adjacent studs 12 and the headers and footers of a wall assembly on the side of the interior wall to thereby provide a moisture/vapor barrier. As With the bag 20, the bag 120 can be cut to size, e.g., as at the cut line 125 shown in FIG. 6, and resealed with a cap 30, 32 and tape 34.

The cover tab 126 can be provided in several ways. For example, the cover tab 126 can be an integral face side of the overall bag 120, i.e., the cover tab 126 can be constructed by outwardly extending one of the face sides of the covering 122. In another example, the cover tab 126 can extend from the sides, i.e., the top, bottom, and lateral sides of the bag 120. In a still further example, the cover tab 126 can be a separate sheet adhered to or attached to one of the faces of the bag 120.

Thus, it can be seen that the thermal insulation properties of the building insulation system 10 counteracts conduction, convection and radiation aspects of thermal energy transfer. The non-porous insulated envelope in a domicile maintains moderate interior temperatures at a comfortable level with minimal heating/cooling energy expenditure and costs. Moreover, the non-porous nature of the bag 20, 120 helps to prevent moisture from developing.

It is to be understood that the building insulation system 10 encompasses a variety of alternatives. For example, the bag 20, 120 can be provided in a variety of different custom shapes to fit various architectural designs. Moreover, select locations thereof can be perforated as deemed necessary by the user to provide limited breathability.

It is to be understood that the present invention is not limited to the embodiments described above, but encompasses any and all embodiments within the scope of the following claims.

What is claimed is:

1. A building insulation system, comprising at least one bag having:
a reflective, non-porous single ply outer covering disposed over the entire bag;
only one type of insulation material disposed inside the at least one bag, whereby, the bag provides a thermal barrier for conduction, radiation and convection factors of thermal energy transfer;
a pair of adjacent studs in a building; and
the at least one bag installed between the pair of adjacent studs, wherein the non-porous integrity of the at least one bag is maintained.

2. The building insulation system according to claim 1, wherein said non-porous outer covering comprises reflective polymeric plastic material for reflecting thermal energy.

3. The building insulation system according to claim 2, wherein said reflective polymeric plastic material comprises polymeric sheet material with reflective metal mixed therein.

4. The building insulation system according to claim 1, wherein said insulation material comprises at least one material selected from a group consisting of fiberglass, cellulose, rockwool, expanded polystyrene, and recycled materials.

5. The building insulation system according to claim 2 further comprising a wrap for capping a cut end of said bag.

6. The building insulation system according to claim 5, further comprising at least one adhesive strip for sealing said wrap around said cut end of said bag.

7. The building insulation system according to claim 1, wherein said non-porous outer covering comprises reflective polymeric plastic material for reflecting thermal energy, the system further comprising a cover flange surrounding a periphery of said bag, the cover flange being adapted for covering adjacent studs, headers and footers of a wall frame to thereby provide a moisture/vapor barrier.

8. The building insulation system of claim 1 further comprising an angled wrap.

9. The building insulation system of claim 1 wherein the covering has a cut line.

10. A building insulation system, comprising:
a pair of adjacent studs in a building;
a bag having a reflective, non-porous outer covering comprised of a polymeric sheet having a reflective material mixed therein;
insulation material disposed within the bag; and
the bag positioned between the pair adjacent studs while maintaining the non-porous outer covering.

11. The building insulation system of claim 7 wherein the cover flange is a separate sheet attached to a face of the bag.

12. A building insulation system, comprising:
a pair of adjacent studs in a building;
a non-porous bag installed between the pair of adjacent studs;
the non-porous bag comprised of a polymeric sheet having a reflective material mixed therein, wherein the bag is non-porous integrity of the bag maintained; and
only one type of insulation material disposed within the reflective bag, wherein the reflective bag provides a thermal barrier for conduction, radiation and convection factors of thermal energy transfer.
